(19) United States
(12) Patent Application Publication
(10) Pub. No.: US 2023/0370806 A1
(43) Pub. Date: Nov. 16, 2023

(54) LOCATION BASED NETWORK INFORMATION

(71) Applicant: Hewlett-Packard Development Company, L.P., Spring, TX (US)

(72) Inventors: ISAAC LAGNADO, SPRING, TX (US); CHRISTOPHER CHARLES MOHRMAN, SPRING, TX (US)

(73) Assignee: Hewlett-Packard Development Company, L.P., Spring, TX (US)

(21) Appl. No.: 18/042,571

(22) PCT Filed: Oct. 23, 2020
(86) PCT No.: PCT/US2020/056970

§ 371 Date: Feb. 22, 2023

(51) Int. Cl. H04W 4/02; H04L 61/50

(52) U.S. Cl. CPC H04W 4/02; H04L 61/50

(57) ABSTRACT

An example electronic device includes a component device. The electronic device also includes a first communication device to: transmit an identifier of the component device to an intermediary device; and receive, from the intermediary device, network information, where the network information is generated based on the identifier and location information of the electronic device. The electronic device also includes a second communication device to communicate with a server using the network information.

### BACKGROUND

An electronic device, such as a laptop computer, a tablet computer, a smart phone, etc. may include a wireless communication device so that the electronic device is able to communicate with another electronic device via a wireless network.

### BRIEF DESCRIPTION OF THE DRAWINGS

Some examples of the present application are described with respect to the following figures:

FIG. 1 illustrates a system to generate location based network information for an electronic device, according to an example;

FIG. 2 illustrates a system to generate location based network information for an electronic device, according to another example;

FIG. 3 illustrates an electronic device to transmit an identifier to generate location based network information, according to an example;

FIG. 4 illustrates an electronic device to transmit location information and an identifier to a server to generate location based network information, according to an example; and

FIG. 5 illustrates an electronic device to generate location based network information, according to an example.

### DETAILED DESCRIPTION

An electronic device may include a plurality of internal component devices, such as a chipset, a graphics card, etc. A component device may communicate with a remote server to perform an operation related to the component device. For example, a component device may receive data from the server to update instructions within the component device. The component device may utilize an active network connection of the electronic device, such as a Wi-Fi connection. However, the network connection may not be suitable for the operation. For example, the network connection may be insecure while sensitive data is exchanged during the operation. Also, the network connection may not have the sufficient bandwidth for the operation, Examples described herein provide an approach to enable an electronic device to establish a connection with a suitable network that is within connection range of the electronic device.

In an example, an electronic device may include a component device. The electronic device may also include a first communication device to: transmit an identifier of the component device to an intermediary device; and receive, from the intermediary device, network information, where the network information is generated based on the identifier and location information of the electronic device. The electronic device may further include a second communication device to communicate with a server using the network information.

In another example, a non-transitory computer-readable storage medium includes instructions that when executed cause a processor of an electronic device to: receive a beacon at a first communication device of the electronic device, where the beacon includes an identifier associated with a component device of another electronic device; in response to receiving the beacon, generate location information that indicates a geographical location of the electronic device; transmit the location information and the identifier to a server via a second communication device of the electronic device to generate network information; and in response to receiving network information, transmit the network information to the loT device via the first communication device.

In another example, a non-transitory computer-readable storage medium includes instructions that when executed cause a processor of an electronic device to: receive an identifier associated with a component device of a first electronic device and a location information of a second electronic device from the second electronic device; in response to a determination that a management operation is to be performed with the loT device, identify a wireless network based on the location information; and transmit network information associated with the wireless network to the second electronic device. Thus, examples described herein may enable an electronic device to connect to a network that is suitable for an operation associated with a component device of the electronic device while saving power by avoiding the need to scan for available networks. In addition, the higher bandwidth communication device may be placed in a powered off state to save power until the electronic device is in a location where the higher bandwidth communication device is needed.

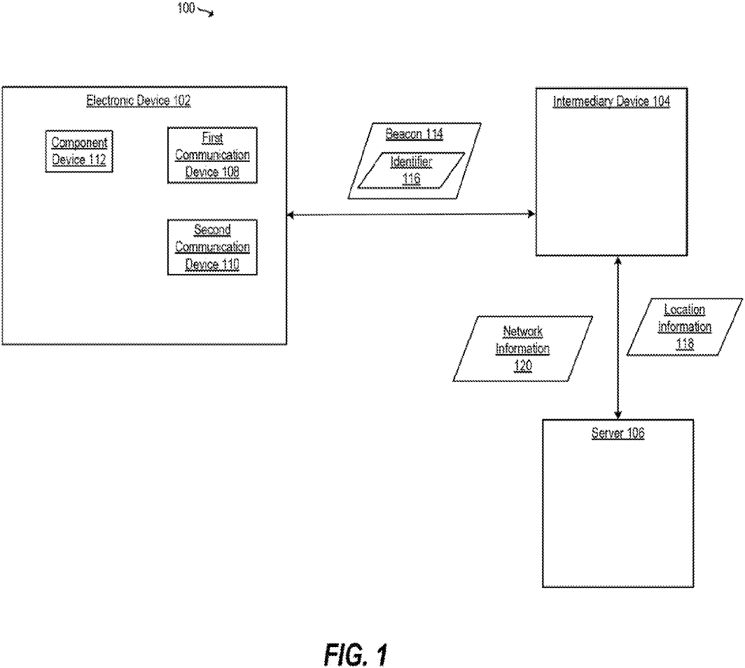

Turning to FIG. 1, FIG. 1 illustrates a system 100 to generate location based network information for an electronic device 102, according to an example. System 100 may include electronic device 102, an intermediary device 104, and a server 106. Electronic device 102 may be, for example, a notebook computer, a desktop computer, an all-in-one system, a tablet computing device, a mobile phone, an electronic book reader, a wearable computing device (e.g., a smart watch), etc. intermediary device 104 may be similar to electronic device 102 or any electronic device that is able to determine the device’s geographical location. Server 106 may be a web-based server, a local area network server, a cloud-based server, etc.

As an example, electronic device 102 may be implemented as a notebook computer, intermediary device 104 may be implemented as a smart phone, and server 106 may be implemented as a cloud-based server. Electronic device 102 may include a first communication device 108, a second communication device 110, and a component device 112. As used here in, component device 112 may be any hardware device, processor executable instruction, circuitry, or combination thereof that performs a function for electronic device 102. Communication devices 108 and 110 may each be transceiver. In some examples, each communication device 108 and 110 may also include a distinct antenna.

During operation, electronic device 102 may transmit a beacon 114 that includes an identifier 116. Identifier 116 may be information that uniquely distinguishes component device 112 from other similar component devices. For example, identifier 116 may be a serial number of component device 112, a media access control (MAC) address of component device 112, a device name of component device 112, or a combination thereof.

Intermediary device 104 may receive beacon 114. In response to receiving beacon 114, intermediary device 104 may determine a current geographical location of intermediary device 104. Intermediary device 104 may transmit identifier 116 and location information 118 that represents the current geographical location to server 106.

In response to receiving identifier 116 and location information 118, server 106 may determine network information 120 based on identifier 116 and location information 118. Network information 120 may be information that enables an electronic device, such as electronic device 102, to establish a connection with a network. Server 106 may transmit network information 120 to intermediary device 104. Intermediary device 104 may in turn transmit network information 120 to electronic device 102. In response to receiving network information 120, electronic device 102 may use second communication device 110 to establish a connection with a network indicated in network information 120. Component device 112 may communicate with server 106 via the network connection to perform a management operation.

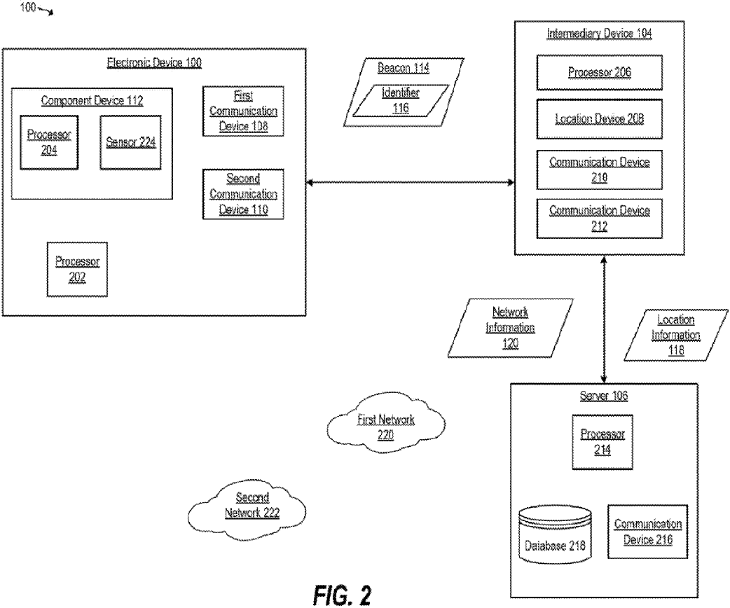

FIG. 2 illustrates system 100 to generate location based network information for electronic device 102, according to another example. In some examples, electronic device 102 may further include a processor 202 that controls operations of electronic device 102. Component device 112 may include a processor 204 that controls the operations of component device 112.

First communication device 108 may implement a first communication standard and second communication device 110 may implement a second communication standard that is different from the first communication protocol. The first communication protocol may consume less power to transmit a signal than the second communication protocol. In some examples, first communication standard may be Bluetooth Low Energy. Second communication standard may be Wi-Fi (e.g., Institute of Electrical and Electronics Engineers (IEEE) 802.11a, 802.11n, etc.).

Intermediary device 104 may include a processor 206 that controls operations of intermediary device 104, a location device 208, communication devices 210 and 212. Communication device 210 may be similar to first communication device 108. Thus, communication device 210 may implement the Bluetooth Low Energy standard. Communication device 212 may be similar to second communication device 110. Thus, communication device 212 may implement the Wi-Fi standard.

As used herein, location device 208 may be any device, circuitry, processor instructions, or a combination thereof that determines location information indicative a current geographical location of location device 208 or a device that incorporates location device 208, such as intermediary device 104. In some example, location device 208 may be implemented as a global positioning system (GPS) receiver. Thus, location device 208 may receive information from global navigation satellite system satellites (e.g., time signals transmitted from the satellites) and determine a geographical location of location device 208. Location device 208 may generate location information 118 that represents the geographical location. The geographical location may be represented as longitude, latitude, elevation, or a combination thereof. In some examples, location device 208 may determine the geographical location via triangulation from cellular towers. Location device 208 may also use other techniques to determine the geographical location.

During operation, electronic device 102 may be in a sleep state. That is, components of electronic device 102 may be powered off to reduce power consumption. In some examples, electronic device 102 may implement the advanced configuration and power interface (ACPI) and the sleep state may be the S1 state, the S5 state, etc. under ACPI. Component device 112 and first communication device 108 may remain in a working state (i.e., powered on and fully functional) when electronic device 102 is in the sleep state.

Component device 112 may broadcast beacon 114 as a low energy radio signal, such as a Bluetooth Low Energy beacon. For example, beacon 114 may be formatted as a Bluetooth Low Energy advertisement frame. Identifier 116 may be included in a payload of the advertisement frame. Component device 112 may broadcast beacon 114 periodically.

When electronic device 102 is in the vicinity of intermediary device 104, intermediary device 104 may receive beacon 114 including identifier 116 via communication device 210. In response to receiving beacon 114, intermediary device 104 may use location device 208 to generate location information 118. Because electronic device 102 is in the vicinity of intermediary device 104, location information 118 may be used as a proxy to indicate the geographical location of electronic device 102. Intermediary device 104 may transmit location information 118 and identifier 116 to server 106.

Server 106 may include a processor 214 that controls the operations of server 106. Server 106 may also include a communication device 216 and a database 218. Server 106 may receive location information 118 and identifier 116 via communication device 216. Communication device 216 may be similar to communication device 212.

Server 106 may determine if a management operation is to be performed with component device 112 based on identifier 116. For example, server 106 may use a lookup table to determine if identifier 116 matches an identifier that is due for a management operation. In response to a determination that component device 112 is due for a management operation, server 106 may search through available network information stored in database 218 to identify a network that is suitable for the management operation. Server 106 may use location information 118 to identify the suitable network.

The suitable network may be at the same geographical location as indicated in location information 118 or within communication range of the second communication device 110. For example, the available network information may indicate that both first network 220 and second network 222 have a respective wireless access point (when first network 220 and/or second network 222 is a wireless networks) or a network port on an Ethernet switch (when first network 220 and/or second network 222 is a wired network) located within communication range of component device 112. Thus, server 106 may determine that a first network 220 and a second network 222 are both within communication range of component device 112.

Server 106 may also determine which of first network 220 and second network 222 satisfies a security parameter associated with the management operation. For example, when the management operation is a firmware upgrade operation with component device 112, the security parameter may have a first value. The first value may be “high”, which indicates that security measure is needed at the suitable network to protect the communication associated with the management operation. As another example, when the management operation is a status update operation, where component device 112 is to provide a status or a heartbeat to server 106, the security parameter may have a second value. The second value may be “low”, which indicates that security measure is optional at the suitable network as the communication associated with the management operation is not sensitive.

First network 220 may employ encryption to protect communication through first network 220. Second network 222 may be an open network where communication on second network 222 is unencrypted. In some examples, second network 222 may be an open network when a password is not needed to join the network. Thus, when the security parameter has the first value, server 106 may select first network 220 as the suitable network since first network 220 is an encrypted network. When the security parameter has the second value, server 106 may select second network 222 as the suitable network since second network 222 is an open network.

Server 106 may generate network information 120 associated with the suitable network. Using first network 220 as an example, network information 120 may include a network credential associated with first network 220, such as a username, a password, a passphrase, or a combination thereof. Network information 120 may also include a name of first network 220, such as a service set identifier (SSID). Server 106 may transmit network information 120 to intermediary device 104 via communication device 216. In response to receiving network information 120, intermediary device 104 may transmit network information 120 to component device 112 via communication device 212. In some examples, intermediary device 104 may broadcast network information 120 as a Bluetooth Low Energy beacon. In some examples, server 106 may generate network information 120 and another server may perform the management operation with component device 112.

In response to receiving network information 120, component device 112 may cause electronic device 102 to transition from the sleep state to a working state, such as S0 state under ACPI. When the electronic device 102 is in the working state, component device 112 may establish a connection with the suitable network (e.g., first network 220) using network information 120 via second communication device 110. When the network connection is established, component device 112 may communicate with server 106 over the Internet via the suitable network. Thus, by connecting to a network that is in communication range of electronic device 102 when a management operation is due for component device 112, electronic device 102 may avoid constantly scanning for network connections using second communication device 110. Thus, the power used to locate a suitable network for the management operation may be reduced.

In some examples, component device 112 may be implemented as an Internet of Things (IoT) device. An IoT device may be a device to sense or monitor information and exchange such information with another loT device or a gateway. Component device 112 may include a sensor 224. Sensor 224 may be used to measure a physical property of the surrounding environment, an aspect of electronic device 102, or a combination thereof.

In some examples, component device 112 may be implemented as a tracking device. Component device 112 may enable another device to locate electronic device 102 in the real world or in a virtual environment. For example, in response to receiving a paging signal, component device 112 may respond with a heartbeat signal and may propagate the heartbeat signal via an hoc network of devices that incorporate tracking devices similar to component device 112. Thus, a relative location of electronic device 102 may be determined if a geographical location of one of the devices on the ad hoc network is known. In some examples, in response to receiving the paging signal, component device 112 may generate an audio alarm so that the person who is tracking electronic device 102 may locate electronic device 102 by following the sound of the alarm.

In some examples, processors 202, 204,206, and 214 may each be a central processing unit (CPU), a semiconductor-based microprocessor, an integrated circuit (e.g., a field-programmable gate array, an application-specific integrated circuit), a chipset, and/or other hardware devices suitable for retrieval and execution of instructions stored in a computer-readable storage medium.

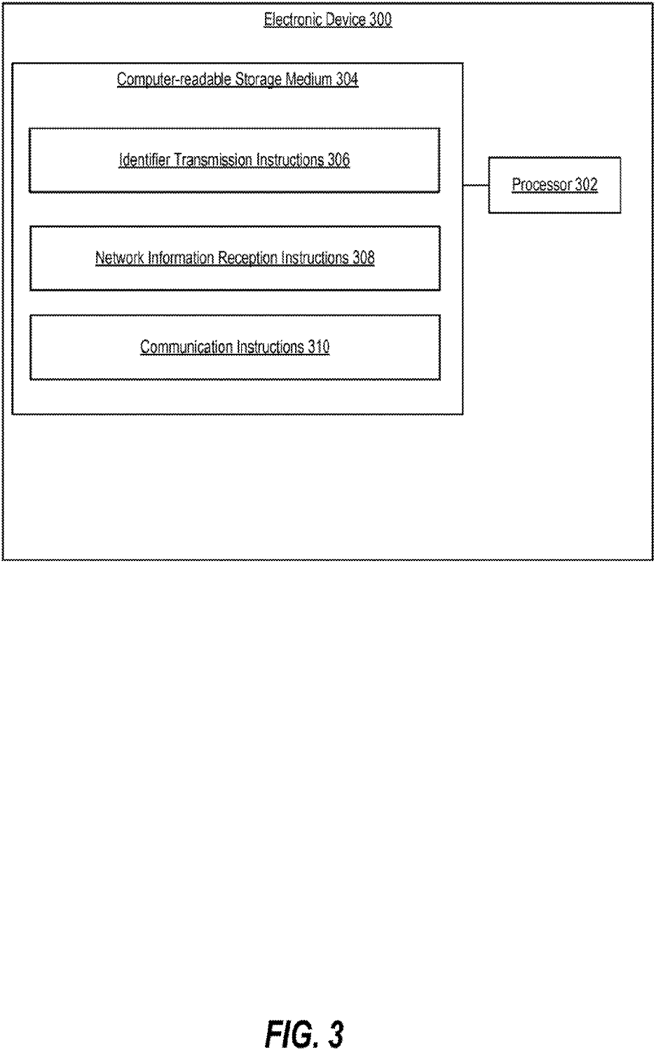

FIG. 3 illustrates an electronic device 300 to transmit an identifier to generate location based network information, according to an example. Electronic device 300 may include a processor 302 and a computer-readable storage medium 304, first communication device 108, second communication device 110, and component device 112. Electronic device 300 may implement component device 112 of FIGS. 1-2.

Processor 302 may be similar to processor 204. Processor 302 may fetch, decode, and execute instructions 306, 308, and 310 to control operations of electronic device 300. Computer-readable storage medium 304 may be any electronic, magnetic, optical, or other physical storage device that contains or stores executable instructions. Thus, computer-readable storage medium 304 may be, for example, Random Access Memory (RAM), an Electrically Erasable Programmable Read-Only Memory (EEPROM), a storage device, an optical disc, etc. In some examples, computer-readable storage medium 304 may be a non-transitory storage medium, where the term “non-transitory” does not encompass transitory propagating signals. Computer-readable storage medium 304 may be encoded with a series of processor executable instructions 306, 308, and 310.

identifier transmission instructions 306 may transmit an identifier of electronic device 300. For example, referring to FIG. 2, component device 112 may broadcast beacon 114 as a Bluetooth Low Energy beacon. Network information reception instructions 308 may receive network information associated with a network. For example, referring to FIG. 1, component device 112 may receive network information 120 from intermediary device 104. Communication instructions 310 may communicate with a server to perform a management operation. For example, referring to FIG. 2, component device 112 may perform a management operation with server 106 via second communication device 110.

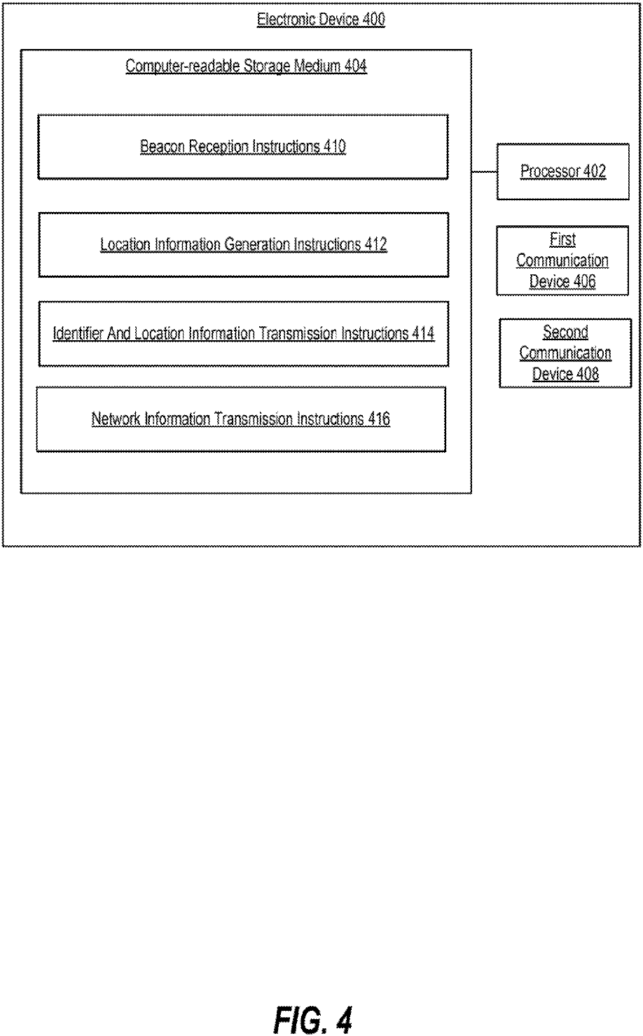

FIG. 4 illustrates an electronic device 400 to transmit location information and an identifier to a server to generate location based network information, according to an example. Electronic device 400 may implement intermediary device 104 of FIGS. 1-2. Electronic device 400 may include a processor 402, a computer-readable storage medium 404, a first communication device 406, and a second communication device 408. Processor 402 may be similar to processor 206. Computer-readable storage medium 404 may be similar to computer-readable storage medium 304 of FIG. 3. First communication device 406 may be similar to communication device 210 of FIG. 2 and second communication device 408 may be similar to communication device 212 of FIG. 2. Computer-readable storage medium 404 may be encoded with a series of processor executable instructions 410, 412, 414, and 416.

Beacon reception instructions 410 may receive a beacon including an identifier of a component device of another electronic device via first communication device 406. For example, referring to FIG. 1, intermediary device 104 may receive beacon 114 including identifier 116 from electronic device 102.

Location information generation instructions 412 may generate a geographical location of electronic device 400. For example, referring to FIG. 2, location device 208 may generate location information 118.

Identifier and location information transmission instructions 414 may transmit an identifier received from another electronic device and location information of electronic device 400 to a server. For example, referring to FIG. 2, intermediary device 104 may transmit identifier 116 and location information 118 to server 106.

Network information transmission instructions 416 may transmit network information associated with a network to another electronic device. For example, referring to FIG. 2, in response to receiving network information 120 from server 106, intermediary device 104 may transmit network information 120 to electronic device 102.

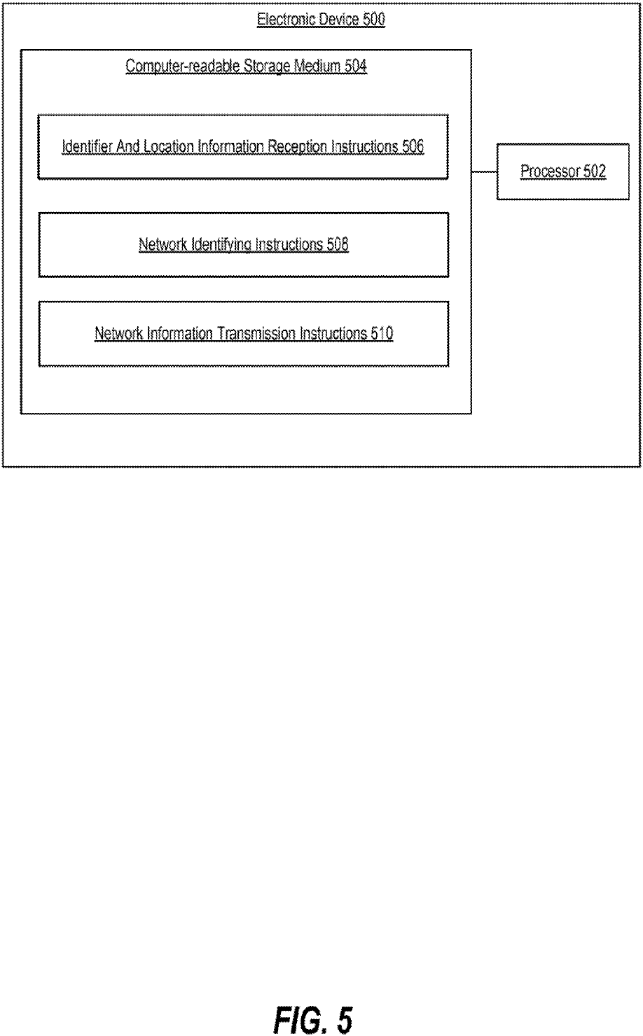

FIG. 5 illustrates an electronic device 500 to generate location based network information, according to an example. Electronic device 500 may implement server 106 of FIGS. 1-2. Electronic device 500 may include a processor 502 and a computer-readable storage medium 504. Processor 502 may be similar to processor 214. Computer-readable storage medium 504 may be similar computer-readable storage medium 304 of FIG. 3. Computer-readable storage medium 504 may be encoded with instructions 506, 508, and 510.

identifier and location information reception instructions 506 may receive an identifier of a first electronic device and location information of a second electronic device from the second electronic device. For example, referring to FIG. 1, server 106 may receive identifier 116 and location information 118 from intermediary device 104.

Network identifying instructions 508 may identify a network based on the identifier and the location information and generate network information associated with the network. For example, referring to FIG. 2, server 106 may identify first network 220 based on identifier 116 and location information 118. Server 106 may generate network information 120.

Network information transmission instructions 510 may transmit the network information to the second electronic device. For example, referring FIG. 2, server 106 may transmit network information 120 to intermediary device 104.

The use of “comprising”, “including” or “having” are synonymous and variations thereof herein are meant to be inclusive or open-ended and do not exclude additional unrecited elements or method steps.

What is claimed is:

1. An electronic device comprising:
a component device;
a first communication device to:
transmit an identifier of the component device to an intermediary device; and
receive, from the intermediary device, network information, wherein the network information is generated based on the identifier and location information of the electronic device; and
a second communication device to communicate with a server using the network information.

2. The electronic device of claim 1, wherein the second communication device is in a sleep state when the identifier is transmitted.

3. The electronic device of claim 2, further comprising a processor, wherein the processor is to:
in response to receiving the network information, change second communication device from the sleep state to a working state; and
when the second communication device is in the working state, establish a network connection with a wireless network using the network information.

4. The electronic device of claim 3, wherein, in response to establishing the network connection, the component device is to perform a management operation with the server via the second communication device.

5. The electronic device of claim 4, wherein, in response to completing the management operation, the processor is to change second communication device from the working state to the sleep state.

6. The electronic device of claim 1, wherein the first communication device is to transmit the identifier via a low energy radio signal.

7. The electronic device of claim 1, wherein the first communication device is to communicate using a first communication protocol, and wherein the second communication device is to communicate using a second communication protocol different from the first communication protocol.

8. A non-transitory computer-readable storage medium comprising instructions that when executed cause a processor of an electronic device to:
receive a beacon at a first communication device of the electronic device, wherein the beacon includes an identifier associated with a component device of another electronic device;
in response to receiving the beacon, generate location information that indicates a geographical location of the electronic device;
transmit the location information and the identifier to a server via a second communication device of the electronic device to generate network information; and
in response to receiving network information, transmit the network information to the component device via the first communication device.

9. The non-transitory computer-readable storage medium of claim 8, wherein the instructions when executed further cause the processor to generate the location information using information from a global navigation satellite system.

10. The non-transitory computer-readable storage medium of claim 8, wherein the beacon is a Bluetooth Low Energy advertisement frame.

11. A non-transitory computer-readable storage medium comprising instructions that when executed cause a processor of an electronic device to:
receive an identifier associated with a component device of a first electronic device and location information of a second electronic device from the second electronic device;
in response to a determination that a management operation is to be performed with the component device, identify a wireless network based on the location information; and
transmit network information associated with the wireless network to the second electronic device.

12. The non-transitory computer-readable storage medium of claim 11, wherein the instructions when executed further cause the processor to identify the wireless network based on a security parameter associated with the management operation.

13. The non-transitory computer-readable storage medium of claim 12, wherein the instructions when executed further cause the processor to:
identify a first wireless network when the security parameter has a first value, and
identify a second wireless network when the security parameter has a second value, wherein the first wireless network is an encrypted network, and wherein the second wireless network is an open network.

14. The non-transitory computer-readable storage medium of claim 12, wherein the management operation is a firmware upgrade operation.

15. The non-transitory computer-readable storage medium of claim 12, wherein the management operation is a status update operation.
